(19) United States
(12) Patent Application Publication
(10) Pub. No.: US 2012/0266527 A1
(43) Pub. Date: Oct. 25, 2012

(54) Production Of Fatty Acid Alkyl Esters From Various Lipid Feedstocks

(75) Inventor: Kenneth L. Erdoes, JR., Humble, TX (US)

(73) Assignee: Endicott Biofuels II, LLC

(21) Appl. No.: 13/450,826

(22) Filed: Apr. 19, 2012

Related U.S. Application Data
(60) Provisional application No. 61/478,213, filed on Apr. 22, 2011.

(51) Int. Cl. C10L 1/19; B01J 19/00

(52) U.S. Cl. 44/388; 422/600; 422/187

(57) ABSTRACT

Systems and processes for commercial production of fatty acid alkyl esters for fuel applications are disclosed, wherein the fatty acid alkyl esters are produced from a lipid feedstock comprising varying component concentrations. The components may include free fatty acids, glycerides, and physical and chemical contaminants. An operator or control system may select a process route to optimize a process parameter such as a throughput of the system based on the concentration of the components. The selected process route may include transesterification and/or an esterification processes, and preliminary processes, such as pre-treatment processes, fatty-acid stripping processes, and a fatty acid distillation processes.

### CROSS-REFERENCE TO RELATED APPLICATIONS

The present application claims benefit of similarly titled U.S. provisional patent application Ser. No. 61/478,213, filed Apr. 22, 2011, which is incorporated by reference herein in its entirety.

### TECHNICAL FIELD

The present invention relates to systems and methods for the production of fatty acid alkyl esters, such as biodiesels, from feedstocks varying in both fatty acid and glyceride concentrations through the use of automated process control and combinations of both transesterification and esterification.

### BACKGROUND

Diesel fuel is a non-renewable, refined petroleum product, which is commonly used as fuel in engines that power trains, ships, large trucks and other vehicles around the world. Because the supply of diesel is limited, industrialized countries have experienced acute shortages and dramatic price increases of such fuels during the past quarter-century. Moreover, diesel engines have been known to discharge relatively high levels of certain pollutants. It would thus be beneficial to replace diesel fuels with cleaner-burning alternatives derived from renewable sources such as farm crops, animal fats and other waste materials.

Naturally occurring oils and fats are known to have high energy content and are therefore considered to be possible replacements or supplements to petroleum diesels. However, producing fuels from these feedstocks, or starting materials made up of oils and fats, has proven to be complex due to several factors including viscosity, gelling, and contaminants contained therein. Chemical approaches have been developed to overcome some of these problems, and fatty acid alkyl esters (FAAE), specifically fatty acid methyl esters (FAME), produced from these feedstocks have been determined to be acceptable diesel fuel replacement and/or additives. In fact, these compounds are not only cleaner burning and renewable, but they generate approximately the same energy content of petroleum diesel.

Transesterification (TE) is one method for producing biodiesel, wherein fatty acids are cleaved from glycerin backbones and reacted with methanol to form fatty acid methyl esters. This type of reaction requires low-contaminant feedstocks (known in the art as “refined feedstocks”) that have high concentrations of glycerides. Moreover, in order to prevent the formation of soaps, which are difficult to remove during downstream processing of FAME in biodiesel production processes, typical TE feedstocks typically contain less than about 0.5% by weight free fatty acids (FFA).

Another method for producing FAAE is through esterification of FFA using alcohols in the presence of a catalyst. As opposed to TE, typical esterification reactions require feedstocks with high concentrations of FFA and low levels of glycerides. In fact, feedstocks with high concentrations of glycerides may lead to excessive reaction times due to slow conversion rates, thereby limiting throughput of a given esterification process and decreasing reaction conversion.

Unfortunately, most commercially viable feedstocks comprise mixtures of contaminants, FFA, and glycerides in varying concentrations. As a result, current biodiesel production processes that utilize only TE or esterification must either purchase expensive, refined feedstocks wherein either FFAs or glycerides are removed, or must install additional secondary processing equipment to generate suitable feedstocks for either the esterification or TE reaction. Not only is such processing expensive, in many cases, a large portion of the initial feedstock is wasted. Therefore, there is a need in the art for processes and systems that efficiently utilize TE and esterification to produce biodiesels from many different types of feedstocks, including feedstocks containing varying FFA and glyceride concentrations.

### SUMMARY OF THE INVENTION

Exemplary embodiments described herein overcome the drawbacks of conventional biodiesel production processes through simultaneous and/or independent TE and esterification. In accordance with the present invention, exemplary FAAE production processes described herein allow a single biodiesel plant to produce high quality FAAE, such as FAME and/or biodiesel, in both continuous and batch processes using feedstocks of varying FFA and glyceride concentrations. FAAE, FAME, and more specifically biodiesel can be produced using either a transesterification or esterification reaction process. These processes allow any lipid feedstock and associated contaminants (i.e., any component of a feedstock that is not a free fatty acid or glyceride) to be processed by utilizing a robust feedstock analysis program and a distributed control system selection route based on feedstock analysis. Through the use of such processes as feedstock analysis, automatic process route selection with independent secondary stream processing, TE/esterification selection, and/or back-end processing of FAAE products, vastly differing feedstocks may be converted by a single plant to FAAE, FAME, and/or biodiesel while optimizing process parameters such as throughput.

In one embodiment, a system for converting a lipid feedstock to a biodiesel fuel meeting the ASTM D6751-10 specification is provided. The system can include, for example, an esterification reactor; a transesterification reactor in communication with the esterification reactor; at least one preliminary processing unit in communication with the esterification reactor and/or the transesterification reactor; and a control system in communication with the esterification reactor, the transesterification reactor, and the at least one preliminary processing unit.

In another embodiment, a method for manufacturing biodiesel from a feedstock is provided. The feedstock can include an amount of free fatty acids, an amount of glycerides, and an amount of contaminants. Generally, the method includes selecting a process route that includes one or more components of a biodiesel production system based on the amount of free fatty acids, the amount of glycerides, and/or the amount of contaminants. The biodiesel production system can include, for example, an esterification reactor; a transesterification reactor in communication with the esterification reactor; at least one preliminary processing unit in communication with the esterification reactor and/or the transesterification reactor; and a control system in communication with the esterification reactor, the transesterification reactor, and the at least one preliminary processing unit. The method also includes introducing the feedstock to the selected process route to thereby form a biodiesel meeting the ASTM D6751-10 Standard.

### BRIEF DESCRIPTION OF THE DRAWINGS

The preferred embodiments of the present invention are illustrated by way of example and not limited to the following figures:

FIG. 1 shows a process flow diagram according to an exemplary embodiment.

### DETAILED DESCRIPTION

Various embodiments and aspects of the invention will be described with reference to details discussed below, and the accompanying drawing will illustrate the various embodiments. The following description and drawing are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions. All terms used herein are intended to have their ordinary meaning in the art unless otherwise provided. Moreover, all percentages listed herein are given in terms of percent by weight of the particular feedstream or feedstock unless otherwise indicated.

As used herein, “biodiesel” or “biodiesel fuel” may be defined as a fuel comprising mono-alkyl esters of long chain fatty acids derived from vegetable oils or animal fats and meeting the requirements of ASTM D6751-10 and/or EN 14214 (2008). As shown in the Tables 1A and 1B below, under these standards, biodiesel must comprise a number of specific properties, such as but not limited to limited methanol, sulfur and glycerin, and such properties are determined according to specific testing methods.

TABLE 1A
ASTM D6751-10 Specification for Biodiesel

| Property | Testing Method | Limits |
|---|---|---|
| Ca & Mg | EN14538 | 5 ppm (max) |
| Flash Point | ASTM D93 | 93° C. (min) |
| Alcohol Control | | |
| 1) Methanol | EN14110 | 0.2% mass (max) |
| 2) Flash Point | ASTM D93 | 130° C. (min) |
| Water & Sediment | ASTM D2709 | 0.05% vol. (max) |
| Kinematic | ASTM D445 | 1.9-4.1 mm²/sec |
| Viscosity 40° C. | | |
| Ash Content | ASTM D482 | 0.01% mass (max) |
| Sulfur | | |
| 1) S 15 Grade | ASTM D5453 | 15 ppm (max) |
| 2) S500 Grade | ASTM D5453 | 500 ppm (max) |
| Copper Strip | ASTM D130 | No. 3 (max) |
| Corrosion | | |
| Cetane | ASTM D613 | 40 (min) |
| Cloud Point | ASTM D2500 | (Report) |
| Carbon Residue | ASTM D4530 | 0.05% mass (max) |
| 100% sample | | |
| Acid Number | ASTM D664 | 0.3 mg KOH/g (max) |
| Free Glycerin | ASTM D6584 | 0.020% mass (max) |
| Total Glycerin | ASTM D6584 | 0.240% mass (max) |
| Phosphorous Content | ASTM D4951 | 0.001% mass (max). |
| Distillation, T90 AET | ASTM D86 | 343° C. (max) |
| Sodium & Potassium | EN14538 | 5 ppm (max) |
| Oxidation Stability | EN15751 | 3 hrs (min) |
| Cold Soak Filtration | | |
| 1) | Annex to ASTM D6751 | 360 s (max) |
| 2) Temp <−12° C. | Annex to ASTM D6751 | 200 s (max) |

TABLE 1B
EN 14214 (2008) Specification for Biodiesel

| Property | Testing Method | Limits |
|---|---|---|
| FAME content | EN 14103 | 96.5% mass (min) |
| Density at 15° C. | EN ISO 3675/EN ISO | 860-900 kg/m³ |
| | 12185 | |
| Kinematic Viscosity | EN ISO 3104 | 3.5-5.0 mm²/sec |
| 40° C. | | |
| Flash Point | EN ISO 2719/EN ISO | 101° C. (min) |
| | 3679 | |
| Sulfur | EN ISO 20846/EN | 10 mg/kg (max) |
| | ISO 20884 | |
| Carbon Residue | EN ISO 10370 | 0.3% mass (max) |
| 100% sample | | |
| Cetane Number | EN ISO 5165 | 51.0 (min) |
| Sulfated Ash | ISO 3987 | 0.02% mass (max) |
| Water | EN ISO 12937 | 500 mg/kg (max) |
| Total Contamination | EN 12662 | 24 mg/kg (max) |
| Copper Band Corrosion | EN ISO 2160 | Class 1 |
| Oxidation Stability at | prEN 15751/EN 14112 | 6 hrs (min) |
| 110° C. | | |
| Acid Value | EN 14104 | 0.5 mg KOH/g |
| | | (max) |
| Iodine Value | EN14111 | 120 (max) |
| Linolenic Acid Methylester | EN 14103 | 12% mass (max) |
| Polyunsaturated (>=4 | EN 14103 | 1% mass (max) |
| Double bonds) Methylester | | |
| Methanol | EN 1410I | 0.2% mass (max) |
| Monoglyceride | EN 14105 | 0.8% mass (max) |
| Diglyceride | EN 14105 | 0.2% mass (max) |
| Triglyceride | EN 14105 | 0.2% mass (max) |
| Free Glycerine | EN 14105/14106 | 0.02% mass (max) |
| Total Glycerine | EN 14105 | 0.25% mass (max) |
| Group I metals | EN 14108/EN 14109/ | 5 mg/kg (max) |
| (Na + K) | EN 14538 | |
| Group II metals | EN 14538 | 5 mg/kg (max) |
| (Ca + Mg) | | |
| Phosphorus | EN 14107 | 4 mg/kg (max) |

It will be appreciated that biodiesel is a species of FAME, which, in-turn, is a species of FAAE. As used herein, the term “FAAE product” will refer to any of FAAE, FAME, and biodiesel.

One aspect of the present invention provides an automated production process for the production of FAAE products from any number of lipid feedstocks having varying properties. The processes and systems described herein may be adapted to industrial scale batch or continuous production processes. For example, the processes and systems described herein may be utilized to process up to 500 kg, 1,000 kg, 5,000 kg, 10,000 kg or more of feedstock per day on a continuous basis. Alternatively, batches of any size up to and including 1,000 kg, 5,000 kg, and 10,000 kg or more of feedstock may be processed.

It is contemplated that feedstocks usable with the processes and methods described herein may vary in such properties as FFA concentration, glyceride concentration, and/or the concentration of any number of contaminants, although other feedstock properties may vary. Although a number of exemplary feedstocks are described herein, it will be appreciated that the invention is not so limited, and the feedstocks usable with the present invention are only limited by the ability of the system to prepare the feedstock or at least a portion of the feedstock (described herein as a “feedstream”) for introduction to either a transesterification reactor or an esterification reactor. Moreover, feedstocks utilized in the present invention may comprise any lipid (i.e. fat, oil, and/or fatty acid) materials, including but not limited to fatty acids having any length between C1-C22 and those having multiple unsaturation sites.

In order to produce FAAE products from widely varying feedstocks, certain embodiments of the present invention utilize combinations of transesterification and esterification reactions, wherein highly refined feedstreams comprising glycerides may be routed towards a transesterification reactor and highly purified feedstreams comprising FFAs may be routed towards an esterification reactor. In one embodiment, the transesterification reaction may occur in a transesterification reactor. The esterification reaction may occur in an esterification reactor. It will be appreciated that the transesterification reactor and esterification reactor may be separate, and, therefore, the transesterification reaction and esterification reaction may occur simultaneously and/or independently. In other words, the instant invention allows for both esterification and transesterification to be employed on two separate feedstreams of a single feedstock at the same time or at different times.

In certain embodiments, various preliminary processing units may be incorporated into exemplary systems in any number of configurations. Such preliminary processing units may include, for example, pre-treatment preliminary processing units, fatty acid stripping units and/or fatty acid distillation units. As discussed below, each preliminary processing unit may receive a feedstream or a feedstock to conduct a chemical or physical process thereon.

In one embodiment, any of the preliminary processing units may produce a main product stream, a secondary stream and/or a by-product. As used herein, a main product stream may be a purified feedstream ready to be received by either of the transesterification or esterification reactors. A secondary stream, on the other hand, is not routed to the transesterification or esterification reactors, but is rather sent to a different preliminary processing unit to be further processed. A by-product, as disclosed herein, is not applicable for further processing in either a reactor or a preliminary processing unit. Instead, any by-product produced may either be removed from the system or collected to be used for other applications, such as but not limited to the production of fuel, soaps, and/or detergents.

Exemplary production processes according to the present invention may be initiated when a feedstock is presented to the system and the concentration of at least one component of the feedstock may be determined either manually or automatically. For example, the concentration of FFAs, glycerides, and/or various contaminants of the feedstock may be determined by an operator or measured automatically by detectors, sensors, indicators or the like attached to a computerized control system (discussed below). Alternatively, an operator may enter any number of individual component concentrations to be determined by the control system.

In one embodiment, a process parameter for optimization may be input and/or stored in the control system such that the control system may process the feedstock to optimize the parameter. For example, an operator who desires to optimize the throughput of a process may enter such a parameter into the control system or such a parameter may be previously stored in memory of the control system. As used herein, throughput refers to a ratio of an output of the system to an input of the system. For example, the throughput may refer to a ratio of the amount FAAE product output by the system to the amount of feedstock used to produce the FAAE product.

Suitable feedstocks to be employed can include any glycerides, lipid material from a plant or vegetable or an animal, as well as recovered lipids. Suitable examples of lipid materials include, but are not limited to, fats, oils, fatty acids, and glycerides. Suitable fatty acids include, but are not limited to, decanoic acid, dodecanoic acid, tetradecanoic acid, hexadecanoic acid, octadecanoic acid, octadecenoic acid, linoleic acid, eicosanoic acid, isostearic acid and the like, as well as mixtures of two or more thereof. Suitable examples of plants and vegetables include, but are not limited to, sunflower, soy, rape, corn, canola, camelina, coconut, palm, olive, jatropha, algae, sunflower, dryland mustard and safflower. Suitable examples of animals include, but are not limited to, cows, sheep, rabbits, pigs, whales, and other rendered animals. Suitable examples of recovered lipids include, but are not limited to, yellow grease, brown grease, Dissolved Air Flotation (“DAF”), and other waste or recovery lipid materials. In certain embodiments, the preferred fatty acids (attached to glycerin or in free form) in the feedstocks range from C1 to C22 in chain length and can have no unsaturation sites. In certain alternative embodiments, the fatty acids have a single unsaturation site. In yet other embodiments, the fatty acids have multiple unsaturation sites. In certain exemplary embodiments, the fatty acid chain length is in the range of C14 to C20. The lipids can be in the form of fatty acid, mono-acylglyceride, di-acylglyceride, or tri-acylglyceride and can be composed of different concentrations of each. The free fatty acid content of the feedstock can vary from about 0 to about 100 percent (%). The glyceride content of the feedstock can vary from about 0 to about 100%. Generally, as the amount of the free fatty acid content in the feedstock decreases, the amount of glycerides in the feedstock increases.

The processes and systems described herein may allow for the optimization (i.e. minimization) of the amount of additives or reactants required to convert an initial feedstock to a FAAE product or of the total cost of additives used. Additives may refer to chemical elements and/or compounds incorporated into the various processing units to convert a given feedstock to a final FAAE product. Thus, because additive and/or reactant usage may largely determine the overall cost of FAAE product production, potential process routes may be determined based, at least in part, on the total amount of additive and/or reactant required, on the ratio of the amount of additives and/or reactants required to FAAE product produced, or even on the number of processes that require additives and/or reactants. Such optimization may be calculated and implemented by the control system or an operator.

One exemplary reactant is alcohol, which may be employed in the transesterification reactor, the esterification reactor, and/or any of the preliminary processing units. A variety of alcohols may be suitable for use in the processes of the present invention, including any C₁₋₂₄ straight, branched, or cyclic alcohols. In certain exemplary embodiments, the alcohol is a monohydric, aliphatic alcohol. In certain embodiments, the alcohol is a primary, secondary, or tertiary alcohol. Preferably, the alcohol is a C₁₋₆ alcohol. It is also preferable for the alcohol to be selected from t-butanol, isobutanol, methanol, ethanol, propanol, isomers of propanol, isomers of butyl and amyl alcohol, isoamyl alcohol, or mixtures thereof.

The esterification reactor and transesterification reactor will preferably comprise one or more catalysts. In certain embodiments, the same catalyst may be employed in both the esterification reactor and the transesterification reactor, although it will be recognized that the either of the reactors may use any of a number of different catalyst.

In one embodiment, the catalysts employed may be solid in nature, and may have acidic functional groups on the surface thereof, or both acidic and basic functional groups. For example, the catalyst may be an ion exchange resin which includes sulfonic acid (—S(O)₂OH) or carboxylic acid (—C(O)OH) reactive groups, or a mixture thereof. Macroreticular resins of this type are preferred. Examples of suitable resins are those sold under the trade marks “Amberlyst”, “Dowex”, “Dow” and “Purolite” such as AMBERLYST 13, AMBERLYST 66, DOW C351, and PUROLITE C150.

In other embodiments, a homogeneous acid or base may be employed to catalyze the esterification or transesterification reactions. Exemplary homogeneous acid catalysts include but are not limited to sulfuric, phosphoric, hydrochloric, hydrobromic, nitric and organic sulphonic acids. Exemplary homogeneous base catalysts include but are not limited to NaOH, KOH, carbonates and alkoxides such as sodium methoxide, ethoxide, propoxide, and butoxide. While many catalysts suitable for performing esterification and/or transesterification can be used in an effective amount and an effective concentration, solid catalysts having acidic functional groups are generally preferred because of the minimization of purification steps required in processing the product stream.

Other suitable catalysts include, but are not limited to, tungstated zirconia, sulfated zirconia, zinc stearate, aluminum dodecatungstophosphate, zinc and lanthanum oxide mixtures, supported or unsupported heteropolyacids, and various hydrotalcite catalysts. In one exemplary embodiment, the catalyst is a heteropolyacid or monovalent cation doped heteropolyacid such as, for example, a composition comprising YₓH₍ₙ₋ₓ₎MX₁₂O₄₀ wherein Y is selected from amongst NH4+, Na+, K+, or Cs+ and wherein X is either W or Mo and wherein M is either P or Si. In another exemplary embodiment, the catalyst is a mixture of zinc oxide and various lanthanum oxides such as, for example, La₂CO₅ and LaOOH, wherein the bulk molar ratio Zn:La may be from about 1:0 to about 4:1. For example, the bulk molar ratio of Zn:LA may be about 1:1, about 2:1, or about 3:1, inclusive. In another embodiment, the catalyst has both Lewis acid and Lewis base sites.

Preferably, the catalyst employed is stable at the temperatures at which the reaction is run. For example, if any of methanol, ethanol, n-propanol, isopropanol, n-butanol or isobutanol are used as the alcohol, then the catalyst (as an ion exchange resin) must be able to be operate at temperatures between 120° C. and 140° C.; preferably having only a moderate activity loss at this temperature range. When alcohols having higher boiling points are employed, the catalyst similarly must be able to operate, and must have only a moderate activity loss, at higher temperatures which correspond to the boiling point of the alcohol being used.

In order to optimize a selected process parameter, such as but not limited to a throughput, a feedstock dependent process route may be determined by the control system. In certain embodiments, the process route may comprise a combination of the transesterification reactor and/or the esterification reactor and/or any number of preliminary processing units. As discussed above, the process route may include any number of main product streams, secondary streams and/or by-products produced by preliminary processing units or even the reactors.

In one embodiment, equipment along the process routes may be controlled using a computer accessible control system. The control system may comprise any general or special purpose computer and/or software stored and/or running on the same. The control system may be operable to control valves, chambers, timing, pH (acidity/basicity), flow rates (dosing), agitation, pressures and/or temperatures, and may include detectors, sensors, indicators or the like to achieve an automated system with manual override options. In an exemplary batch process, the process route may be automatically determined by the control system based on automatic analysis of the feedstock and manual input of process parameters to be optimized. Similarly, process routes may be automatically determined in continuous processes, and delays may optionally be introduced into the system such that continuous analysis of each feedstream assures that the process parameter entered is continually optimized.

In another exemplary embodiment, the control system may be adapted to display a number of potential process routes on a screen for operator selection after an analysis of the feedstock is conducted and the process parameter is inputted. In this way, the operator may select one of a number of suitable process routes. Exemplary process routes to be displayed on a screen include, the fastest or quickest route for production of the FAAE product, the route that may optimize a throughput (e.g., FAAE product to feedstream input) the route requiring the least amount of supplemental additives, and/or the route that maximizes contaminant removal for FAAE product generation.

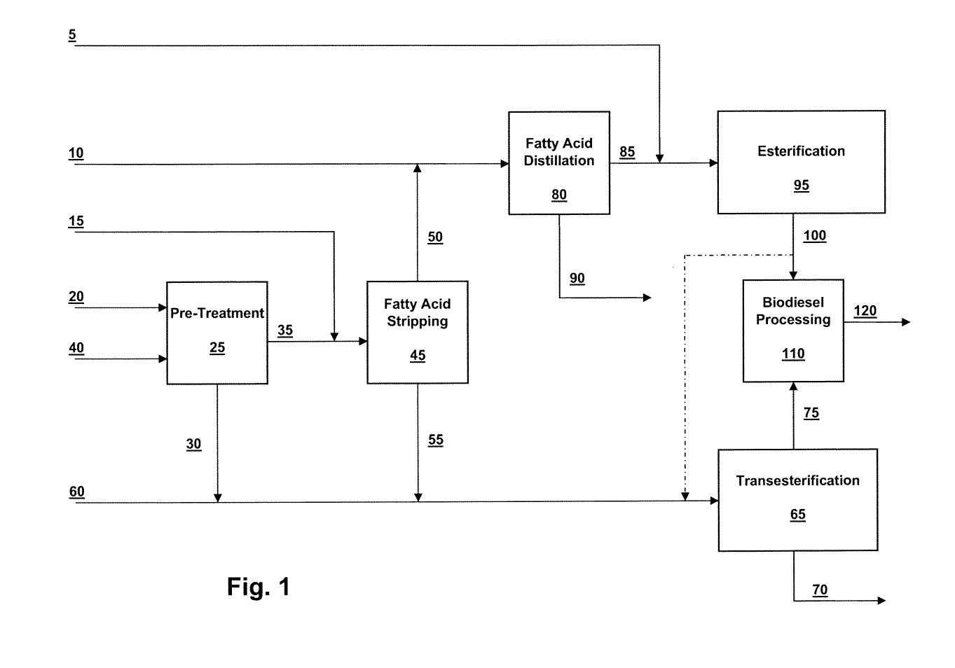

Referring to FIG. 1, a number of exemplary process routes for FAAE product production from feedstreams varying in concentrations of glycerides, FFAs, and/or contaminants 5, 10, 15, 20, 40, and 60 are illustrated. As shown, both an esterification reactor 95 and a transesterification reactor 65 may be included in an exemplary system, although only one need be utilized in any given FAAE product production process route. It will be noted that, in each of the exemplary process routes discussed herein, the transesterification reactor 65 and/or the esterification reactor 95 may produce biodiesel. However, in one embodiment, if the FAAE produced by either the transesterification reactor 65 or the esterification reactor 95 requires additional downstream processing to meet any of the requirements of the ASTM D6751-10 specification, a biodiesel processing unit 110 may convert such FAAE 100, 75, into biodiesel 120. Exemplary biodiesel processing units 110 may comprise such equipment as, for example, settlement tanks, reboiled stripping units, inert gas stripping units, physical absorption units, water washing units, as well as ion exchange beds and/or any combination thereof.

In one embodiment, the esterification reactor 95 may be any esterification reactor, such as but not limited to: a batch reactor, a Continuous Stirred Tank Reactor (CSTR), or a plug flow reactor. Preferably, the esterification reactor 95 may be a reactive distillation esterification reactor, such as that described in U.S. Pat. No. 5,536,856 to Harrison et al, incorporated by reference herein in its entirety.

The transesterification reactor 65 may comprise any of a number of TE reactors including but not limited to batch reactors, continuous reactors, and CSTRs In one embodiment, the transesterification reactor 65 may be adapted to remove glycerin 70 from feedstreams and/or feedstocks introduced thereto.

As shown, a number of preliminary processing units 25, 45, and 80 may be employed in exemplary systems for treatment of the various feedstocks and/or feedstreams. As shown, a preliminary processing unit 25, 45, and 80 may directly receive a feedstock 10, 15, 20, and 40 or may receive a secondary stream from another preliminary processing unit 35 and 50.

In some embodiments, at least one pre-treatment preliminary processing unit 25 is employed in the process route. Pre-treatment preliminary processing units 25 may comprise various feedstock and/or feedstream cleaning units, including but not limited to water degumming units, acid degumming units, silica treatment units, filtration units and/or bleaching units. Refining operations implemented in one pre-treatment preliminary processing unit 25 may allow for the removal of numerous contaminants potentially found in an initial feedstock, such as dirt, color, polyethylene and/or metals. These refining operations may be implemented to clean a feedstock prior to entry into any one of the remaining preliminary processing units 45, 80 or reactors 95, 65. It will be appreciated that, although only one pre-treatment preliminary processing unit 25 is shown in FIG. 1, any number may be employed depending on the initial feedstock and final FAAE product desired.

In certain exemplary embodiments, a fatty acid stripper 45, may be included in the process route to remove FFAs, light boilers, and color bodies from a feedstock. The fatty acid stripper (“fatty acid stripping preliminary processing unit”) may comprise equipment capable of containing a feedstock contained therein at temperatures of up to about 450° F. and pressures of less than about 10 mmHG.

In yet other exemplary embodiments, a fatty acid distillation preliminary processing unit 80 may be included in the process route to remove heavy materials such as metals, glycerides and/or polymerized products (“pitch”) from fatty acid-containing feedstreams and to ensure that such feedstreams may be converted to the highest quality FAAE product by the esterification reactor 95. It is contemplated that the fatty acid distillation preliminary processing unit 80 may be capable of containing a feedstock contained therein at a temperature of up to about 450° F. and pressures of less than about 10 mmHG.

In a first exemplary embodiment, a highly refined oil feedstock 60, such as but not limited to RBD, may be detected by the control system and routed by the control system directly to the transesterification reactor 65 without any processing by preliminary processing units 25, 45, 80. The components of an exemplary highly-refined, glyceride feedstock 60 are shown in Table 2 below.

TABLE 2

| Component | Allowable Concentration |
|---|---|
| Glycerides | ≧about 98.0% |
| FFA | ≦about 2% |
| Phosphorous | ≦about 20 ppm |
| Unsaponifiables | ≦about 1% |
| Sulfur | ≦about 10 ppm |
| Other Impurities | ≦about 0.1% |

In one embodiment, the control system may be programmed to route any feedstream or feedstock having the properties of Table 2 directly to the transesterification reactor 65. Accordingly, when an RBD feedstock 60 or feedstream having similar properties (e.g., feedstreams 30, 55) is detected by the control system, it may be introduced directly to the transesterification reactor 65 such that a highly refined FAAE product 120 may be produced.

In a second exemplary embodiment, a highly-purified fatty acid feedstock comprising FFAs 5 may be detected by the control system and fed directly to an esterification reactor 95. The components of an exemplary highly-purified fatty acid feedstock are shown in Table 3 below.

TABLE 3

| Component | Allowable Concentration |
|---|---|
| FFA | ≧about 90% |
| Glycerides | ≦about 10% |
| Phosphorous | ≦about 20 ppm |
| Unsaponifiables | ≦about 1% |
| Sulfur | ≦about 10 ppm |
| Metals | ≦about 2 ppm |
| Water | ≦0.1% |
| Chloride | ≦about 9 ppm |
| Peroxides | ≦about 10 ppm |
| Color | ≦about 30 yellow, ≦about 3 red |

In one embodiment, the control system may be programmed to route any feedstream or feedstock having the properties listed in Table 3 directly to the esterification reactor 95. Accordingly, when a highly purified, fatty acid feedstock 5 or feedstream 85 is detected by the control system, it may be introduced directly to the esterification reactor 95 such that a highly refined FAAE product may be produced. In certain embodiments, highly purified, fatty acid feedstocks 5 or feedstreams 85 may be converted to FAAE products at conversion rates approaching 100% via an esterification reactor 95 employing reactive distillation with a heterogeneous catalyst.

In one exemplary embodiment, a contaminant-containing, low fatty acid (CCLFA) feedstock 20 may be detected by a control system and converted to biodiesel via a selected process route. Exemplary properties of a CCLFA feedstock 20 are shown in Table 4, below.

TABLE 4

| Component | Concentration |
|---|---|
| Glycerides | ≧ about 98.0% |
| FFA | ≦about 2% |
| Phosphorous | ≦about 1000 ppm |
| Unsaponifiables | ≦about 2% |
| Sulfur | ≦about 15 ppm |
| Other Impurities | ≦1% |

As shown, a CCLFA feedstock 20 may be introduced to a pre-treatment preliminary processing unit, such that contaminants such as dirt, color, polyethylene and/or metals may be removed therefrom. Once reacted or cleaned in one or more pre-treatment preliminary processing units 25, a main product stream 30 may be produced comprising, for example, less than about 10 ppm phosphorous, less than about 1% FFAs, less than about 1% unsaponifiables, less than about 10 ppm sulfur, and less than about 0.1% other impurities. Accordingly, an exemplary control system may route the main product stream 30 directly to the transesterification reactor 65 such that a FAAE product may be produced thereby. It will be noted that either an operator or the control system of the present invention may determine whether the feedstream produced by a preliminary processing unit (e.g. 25) is a main product stream (e.g., 30) suitable for introduction to a transesterification reactor (e.g., 65), or whether such a feedstream is a secondary stream (e.g., 35, discussed below), which must be further routed to another preliminary processing unit such as a fatty acid stripping preliminary processing unit 45 or back through the same preliminary processing unit (e.g., 25) for further cleaning (not shown).

In another embodiment, a contaminant-containing, high fatty acid (CCHFA) feedstock 40 may be detected by the control system. An exemplary CCHFA feedstock 40 may comprise similar levels of phosphorous, sulfur, unsaponifiables, and other impurities as described in Table 4 above, but may comprise up to about 20% FFA and up to about 500 ppm soaps. In this embodiment, once the CCHFA feedstock 40 is introduced to the pre-treatment preliminary processing unit 25, a secondary stream 35 may be produced therefrom such that the secondary stream 35 may be further processed before being sent to a reactor 95, 65. It will be recognized that after pre-treatment of either a CCLFA feedstock 20 or CCHFA feedstock 40, either a secondary stream 35 or main product stream 30 leaves the pre-treatment preliminary processing unit 25 with reduced concentration of phosphorous and/or unsaponifiables contaminants, for example, but may still contain significant concentrations of both FFA and glycerides if these compounds are present in the initial feedstock (e.g., 40). By way of example, the secondary stream 35 may comprise the components listed in Table 5.

TABLE 5

| Component | Concentration |
|---|---|
| FFA | ≦ about 20% |
| Glycerides | ≧about 80% |
| Phosphorous | ≦about 20 ppm |
| Unsaponifiables | ≦about 1% |
| Sulfur | ≦about 10 ppm |
| Metals | ≦about 2 ppm |
| Water | ≦about 0.1% |
| Chloride | ≦about 9 ppm |
| Peroxides | ≦about 10 ppm |
| Color | ≦about 30 yellow, ≦about 3 red |

It will be appreciated that, although a feedstream with the properties of Table 5 may be produced as discussed above (e.g. secondary stream 35), a feedstock with these or similar properties (e.g., 15) may also be introduced into the system without preliminary processing. Moreover, such feedstreams 35 and feedstocks 15 may be combined by an operator or control system or may be maintained as separate streams. Nevertheless, the level of FFAs present (up to about 20%) in such a feedstream 35 or feedstock 15 may cause the prevention of its direct introduction to a reactor 65, 95 (see Tables 2 and 3). Accordingly, the secondary stream 35 or feedstock 15 may be routed to a preliminary processing unit 45 for treatment. As shown, the secondary stream 35 and/or feedstock 15 may be routed to a fatty acid stripping preliminary processing unit 45, where FFAs may be stripped away from glycerides to produce a main product stream 55 having a high concentration of glycerides and/or a secondary stream 50 highly concentrated in FFAs. For example, the refined glyceride main product stream 55 may comprise the components listed in Table 5, with the exception that the FFA concentration may now be less than about 1%, and preferably less than about 0.25% as a result of the fatty acid stripping. Accordingly, the main product stream 55 may be directed to the transesterification reactor 65, without further processing, as it will meet the requirements of Table 2, above.

A crude FFA secondary stream 50 produced by the fatty acid stripping preliminary processing unit 45, by contrast, may comprise the properties listed in Table 6, below.

TABLE 6

| Component | Concentration |
|---|---|
| FFA | about 70% to about 90% |
| Glycerides | about 10% to about 30% |
| Phosphorous | ≦about 10 ppm |
| Unsaponifiables | ≦about 1% |
| Sulfur | ≦about 10 ppm |
| Other Impurities | ≦0.1% |
| Chloride | ≦about 9 ppm |
| Peroxides | ≦about 10 ppm |
| Color | ≦about 30 yellow, ≦about 3 red |

It will be appreciated that, although a feedstream with the properties of Table 5 may be produced as discussed above (e.g. secondary stream 55), such a feedstream may also be introduced to the system as an initial feedstock 10, without preliminary processing. Moreover, such feedstreams 55 and feedstocks 10 may be combined by the control system or maintained as separate streams. Nevertheless, because the secondary stream 50 and/or feedstock 10 do not meet the requirements listed in Table 3, above, both may be further routed to another preliminary processing unit, such as a fatty acid distillation preliminary processing unit 80.

As shown, the fatty acid distillation preliminary processing unit 80 may remove heavy materials from the secondary stream 50 and/or feedstock 10 to produce a main product stream 85 comprising from about 90% to about 99.9% fatty acids and meeting the requirements of Table 3. Accordingly, the main product stream 85 may be directed to the esterification reactor 95 such that a FAAE product is produced. In one embodiment, a by-product 90, such as boiler fuel, may also be produced by the fatty acid distillation preliminary processing unit 80. Such a by-product may be automatically collected and/or removed from the system.

Modifications and variations of the present invention relating to the selection of reactors, feedstock, alcohols and catalysts are intended to come within the scope of the claims. Further, it is understood by those skilled in the art that the drawings are diagrammatic, and that further items of equipment such as reflux drums, pumps, vacuum pumps, temperature sensors, pressure sensors, pressure relief valves, control valves, flow controllers, level controllers, holding tanks, storage tanks, and the like may be required in a commercial plant. The provision of such ancillary items of equipment is in accordance with conventional chemical engineering practice. Moreover, all numerical values are understood to be prefaced by the term “about” where appropriate. All references cited herein are hereby incorporated by reference in their entirety. The embodiments described above are intended to be exemplary. One skilled in the art recognizes that numerous alternative components and embodiments that may be substituted for the particular examples described herein and still fall within the scope of the invention.

What is claimed is:

1. A system for converting a lipid feedstock to a biodiesel fuel meeting the ASTM D6751-10 specification comprising:
an esterification reactor;
a transesterification reactor in communication with the esterification reactor;
at least one preliminary processing unit in communication with the esterification reactor and/or the transesterification reactor; and
a control system in communication with the esterification reactor, the transesterification reactor, and the at least one preliminary processing unit.

2. The system of claim 1 further comprising at least one biodiesel processing unit in communication with the esterification reactor and/or the transesterification reactor.

3. The system of claim 2, wherein the at least one biodiesel processing unit comprises one or more of the group consisting of a settlement tank, a reboiled stripping unit, an inert gas stripping unit, a physical absorption unit, a water washing unit, an ion exchange unit and combinations thereof.

4. The system of claim 1, wherein the esterification reactor comprises a reactive distillation esterification reactor.

5. The system of claim 4, wherein the esterification reactor comprises a solid heterogeneous catalyst containing the chemical group —SO₃H or —COOH.

6. The system of claim 4, wherein the esterification reactor comprises one or more alcohols selected from the group consisting of t-butanol, isobutanol, methanol, ethanol, propanol, isomers of propanol, isomers of butyl and amyl alcohol, and isoamyl alcohol.

7. The system of claim 1, wherein the at least one preliminary processing unit is selected from the group consisting of a pre-treatment unit, a fatty acid stripper, a fatty acid distillation unit and combinations thereof.

8. The system of claim 7, wherein the pre-treatment unit is selected from the group consisting of an acid degumming unit, a dry degumming unit, a bleaching unit, a silica filtration unit, a water degumming unit, and a super degumming unit.

9. The system of claim 1, wherein the at least one preliminary processing unit comprises a pre-treatment unit, a fatty acid stripper, and a fatty acid distillation unit.

10. The system of claim 1, wherein the control system is adapted to optimize a process parameter.

11. The system of claim 10, wherein the control system optimizes a process parameter through selection of a feedstock-dependent process route.

12. The system of claim 11, wherein the process parameter is throughput.

13. A method for manufacturing biodiesel from a feedstock comprising an amount of free fatty acids, an amount of glycerides, and an amount of contaminants, the method comprising:
selecting a process route comprising one or more components of a biodiesel production system based on the amount of free fatty acids, the amount of glycerides, and/or the amount of contaminants, wherein the biodiesel production system comprises:
an esterification reactor;
a transesterification reactor in communication with the esterification reactor;
at least one preliminary processing unit in communication with the esterification reactor and/or the transesterification reactor; and
a control system in communication with the esterification reactor, the transesterification reactor, and the at least one preliminary processing unit; and
introducing the feedstock to the selected process route to thereby form a biodiesel meeting the ASTM D6751-10 Standard.

14. The method of claim 13, wherein the feedstock comprises greater than about 90% free fatty acids, less than about 10% glycerides, and less than 1% contaminants, and the selected process route comprises the esterification reactor.

15. The method of claim 13, wherein the feedstock comprises greater than about 98% glycerides, less than about 2% free fatty acids, and less than 1% contaminants, and the selected process route comprises the transesterification reactor.

16. The method of claim 13, wherein the feedstock comprises from about 70% to about 90% fatty acids, and from about 10% to about 30% glycerides and the selected process route comprises the preliminary processing unit followed by the esterification reactor.

17. The method of claim 16, wherein the feedstock is subjected to fatty acid distillation in the preliminary processing unit.

18. The method of claim 17, wherein the feedstock is subjected to pre-treatment at a second preliminary processing unit prior to being subjected to the fatty acid distillation.

19. The method of claim 13, wherein the feedstock comprises about 20% or less free fatty acids, about 80% or greater glycerides, and the selected process route comprises a first and second preliminary processing unit and the esterification reactor and/or the transesterification reactor.

20. The method of claim 19 further comprising:
subjecting the feedstock to fatty acid stripping at the first preliminary processing unit to produce a first main product stream and a secondary stream;
subjecting the secondary stream to fatty acid distillation at the second preliminary processing unit to produce a byproduct and a second main product stream;
introducing the first main product stream to the transesterification reactor; and
introducing the second main product stream to the esterification reactor;

21. The method of claim 18, wherein the selected process route further comprises a pre-treatment preliminary processing unit.

22. The method of claim 13, wherein the process route is selected to optimize at least one parameter.

23. The method of claim 22, wherein the parameter is throughput.
